(19) United States
(12) Patent Application Publication
(10) Pub. No.: US 2013/0073446 A1
(43) Pub. Date: Mar. 21, 2013

(54) SYSTEM AND METHOD FOR CONFIGURING A VARIABLE COLLATERAL REVOLVING SECURITY

(71) Applicants: Steven Ping Hung Lee, Maple (CA); Mark Chi Thanh Luong, Toronto (CA)

(72) Inventors: Steven Ping Hung Lee, Maple (CA); Mark Chi Thanh Luong, Toronto (CA)

(73) Assignee: NEWBRIDGE ADVANTAGE (1179711 ONTARIO INC.), Markham, ON (CA)

(21) Appl. No.: 13/701,109

(22) PCT Filed: Jun. 2, 2011
(86) PCT No.: PCT/CA2011/000644

§ 371 Date: Nov. 30, 2012

Related U.S. Application Data
(60) Provisional application No. 61/350,980, filed on Jun. 3, 2010.

(51) Int. Cl. G06Q 40/02

(52) U.S. Cl. 705/38

(57) ABSTRACT

A system and method for configuring, recognizing, and utilizing collateral security and account payments is provided to preserve/improve a borrower's credit history with credit bureaus. Collateral deposit data indicative of collateral deposits is periodically received at a computing device and stored in association with a security account in a first memory device. Line of credit data indicative of a line of credit is generated, the line of credit data comprising an indication of a predetermined credit limit based on the collateral deposit data, the line of credit data stored in association with a secured line of credit account at one or more of the first memory device and a second memory device. Periodic transfers of collateral security data associated with the security account occur to settle any outstanding balance associated with the line of credit.

### CROSS-REFERENCE TO RELATED APPLICATIONS

The present application claims priority from U.S. Provisional Patent Application No. 61/350,980 filed on Jun. 3, 2010, the contents being incorporated herein by reference.

### FIELD

This application generally relates to computing devices, in particular to the system and methods for configuring, recognizing, and utilizing collateral security.

### BACKGROUND

Current forms of secured credit instruments involve taking a security as collateral. This collateral security can be any monetary or securities assets, tangible assets, real assets, or intellectual properties. Based on the collateral held, a sum of money is extended and/or advanced from a lender to a borrower (also referred herein as“client”) as a credit instrument. The credit instrument can be a secured revolving line of credit account, a loan, or mortgage. For simplicity, this application will focus the discussion of credit instruments as a secured line of credit. A secured line of credit can be defined as a line of credit that is secured by collateral assets (for example, a borrower's home).

Typically, a line of credit is a revolving credit instrument, which allows the borrower to withdraw funds (drawing on the credit line) and pay back the money owed to the lender at any time or as per agreement. The process of drawing out and paying down on the account will continue until the account is terminated.

Interest is typically charged by the lender to the borrower on the outstanding sum advanced to the borrower. Interest is charged to the borrower on the outstanding balance compounded at an interest rate predetermined by the lender. Based on the type of credit instrument, interest can be calculated in a number of different ways. For example, interest can be compounded monthly, weekly, or daily. Further, this rate can either be fixed or floating based on the banks' prime rate plus/minus some percentage points (for example, prime plus 2%).

The borrower is expected to make periodic [or interval] payments to the line of credit or credit instrument, which can be interest only or a combination of interest plus principal. If the borrower defaults on the line of credit, the lender can take the collateral security to satisfy payments on the account. Typically, the secured asset would be sold and the proceeds from that sale would be applied to pay the outstanding debt.

In cases where the collateral is not enough to pay the debt, the borrower is responsible for the outstanding balances until it is paid in full. The transaction and payment history from these credit instruments are typically reported to a credit bureau. The information collected from credit reporting agencies are processed by Credit Bureaus to determine a borrower's credit score and reports the history of all reported credit accounts on the borrower's credit profile.

There are different forms of credit instruments and as there are ways for lenders to disburse funds to the borrower. For example, funds can be taken either as cash, by cheques (checks) written against the account, advanced through a credit card or a prepaid card, advanced through a debit card, and transferred electronically from one account to another. As technological innovation progresses lenders will have more ways to disburse money and borrowers will have more ways through which they can access or use funds (money). The ways that a borrower can take funds from a credit instrument will depend on the lender's disbursement medium. It should be recognized that different disbursement mediums may be used to draw funds from a credit instrument.

Current forms of secured credit instruments/products require the borrower/client to have access to large capital reserves, and ongoing cash flows in order to build and improve their credit. Otherwise, the client is subjected to extra interest charges on carrying balances from their credit facility account. It should be noted that carrying excessive balances on a credit facility account, which most people will do, if they do not have excess cash flow to pay down or pay off their account balances, can work against the improvement to their credit bureau profile. For example, it is ideal not to have more than 50% account utilization; in other words, a person should carry a balance not more than 50% of the account limits from month to month or it will adversely affect a person's credit profile.

Current secured credit instruments do not dispose or liquidate the collateral until the borrower is in default and seriously delinquent in his/her obligations. At this point, the borrower's credit is tarnished and the relationship with the lender is usually terminated. Accordingly, there is a need to restructure the system and methods for configuring, recognizing, and utilizing collateral security to preserve and improve a borrower's credit profile.

### SUMMARY

The object of this application is an electronic system and method for configuring, recognizing, and utilizing collateral security and account payments to build, preserve and improve a borrower's credit history with various credit bureaus. The proposed methodology consists of a variable collateral revolving secured line of credit which eliminates the problems of requiring the client to have surplus cash flow for monthly payments in addition to the fixed security deposit with the lender. Furthermore, this application will show how utilizing a computing device to help the client to maintain a low rate of credit utilization without requiring the client to have additional cash flow.

Borrowers are underwritten and are approved for a certain credit limit based on the lender's underwriting guideline which may include but is not limited to credit history, payment capacity and character profile. The credit limit represents the limit of security account and the maximum available limit of the borrower's line of credit account. The borrowers do not need to make payment directly to the line of credit account in order to settle their obligations from their line of credit. Instead, at the end of each interval [or monthly] period, the collateral security in the security account is surrendered automatically, on a first in first out basis, to seamless settle the outstanding balance in the line of credit account. The borrower, in turn, makes deposits electronically to the Security Account on a regular basis each month [or interval period] and periodically can also make, in the same interval [or monthly] period, “on-demand” requests when there are needs to increase the available limit in their line of credit account.

Other aspects and features of the present application will become apparent to those ordinarily skilled in the art upon review of the following description of specific embodiments of in conjunction with the accompanying figures.

### BRIEF DESCRIPTIONS OF THE DRAWINGS

For a better understanding of the various implementations described herein and to show more clearly how they may be carried into effect, reference will now be made, by way of example only, to the accompanying drawings in which:

FIG. 1 depicts block diagram illustrating the traditional method for allocating collateralized/secured credit instruments, according to the prior art.

FIG. 2 depicts a block diagram illustrating a methodology for a variable collateral revolving secured line of credit, according to non-limiting implementations.

FIG. 3 depicts a block diagram illustrating various types of disbursement mediums, according to non-limiting implementations.

FIGS. 4A-4G depict flow charts illustrating the flow of information and the various relationships between different system processes for a variable collateral revolving secured line of credit, according to non-limiting implementations.

FIG. 5 depicts a system for configuring a collateral security. according to non-limiting implementations.

Same reference numerals are used in different figures, where appropriate, to denote similar elements.

### DETAILED DESCRIPTION

This application proposes a variable collateral revolving secured line of credit to provide a solution to an existing problem of bad credit that current financial instruments/products is not being solved. The objective of the variable collateral revolving secured line of credit is to allow the borrower to establish credit without the need of a large capital reserve and cash flow while avoiding high interest cost associated with traditional types of secured credit instruments.

The variable collateral revolving secured line of credit allows the borrower to establish credit without access to large capital reserves and surplus cash flow because the system dynamically recognizes and utilizes the security to pay existing credit advances [or debts] on account. Furthermore, the systematic monthly payments made by borrower/client to their security account keeps carrying balances to a minimum from month to month; therefore, avoiding large carrying balances that can adversely affect a client's credit score (or profile).

An aspect of the application provides a computing device for configuring a collateral security, comprising: a processor, and a communication interface, the processor enabled to: periodically receive, via the communication interface, collateral deposit data indicative of collateral deposits; cause the periodic collateral deposit data to be stored in association with a security account in a first memory device; generate line of credit data indicative of a line of credit, the line of credit data comprising an indication of a predetermined credit limit based on the collateral deposit data, the line of credit data stored in association with a secured line of credit account at one or more of the first memory device and a second memory device; and periodically cause a transfer of collateral security data associated with the security account to settle any outstanding balance associated with the line of credit.

The processor can be further enabled to cause a disbursement medium to be issued for enabling funds associated with the line of credit to be accessed. The disbursement medium can comprise at least one of a prepaid card, a secured credit card, a debit card and a checking account. The processor can be further enabled to verify a payment balance associated with the disbursement medium, prior to transmitting payment data for transferring funds from the secured line of credit account to an account associated with the disbursement medium.

The processor can be further enabled to cause transaction data associated with the transfer to be transmitted to a remote computing device associated with a credit bureau to thereby reporting a transaction history associated with the secured line of credit account.

The processor can be further enabled to determine the predetermined credit limit by subtracting from an amount associated with the collateral deposit data amounts associated with at least one of applicable fees, interest charges, advances, and payments. The applicable fees can comprise one or more of at least one transaction fee and a debit non-sufficient funds (NSF) fee.

The processor can be further enabled to receive, via the communication interface, further collateral deposit data indicative of further collateral deposits. A total amount associated with the collateral deposit data and the further collateral deposit data does not exceed the predetermined credit limit.

The processor can be further enable to determine credit balance data associated with the secured line of credit account on a periodic basis. The processor can be further enabled to cause transfer of payment to the secured line of credit account using a calculated available collateral balance from an immediately previous period such that funds deposited from the immediately previous period which are in the security account are automatically used to pay off an outstanding balance in the secured line of credit account at the end of a present period.

Periodic receipt of the collateral deposit data and periodic transfer of the collateral security data can each occur monthly on a first in first out basis.

Another aspect of the specification provides a system for configuring a collateral security, comprising: a server enabled to control systems processes and store data for client and user services, the server further enabled to: periodically receive collateral deposit data indicative of collateral deposits; cause the periodic collateral deposit data to be stored in association with a security account; generate line of credit data indicative of a line of credit, the line of credit data comprising an indication of a predetermined credit limit based on the collateral deposit data, the line of credit data stored in association with a secured line of credit account; and periodically cause a transfer of collateral security data associated with the security account to settle any outstanding balance associated with the line of credit.

The system can further comprise a database for storing at least one of: an EFT/ACH (electronic fund transfer/automated clearing house) transfer table; client account information; user account information; a transaction fee look-up table;

a security account table; a line of credit account table; a disbursement medium table; and a user access table.

The system can further comprise a disbursement medium grantor entity for issuing at least one disbursement medium for enabling funds associated with the line of credit to be accessed.

The server can be further enabled to determine credit balance data associated with the secured line of credit account on a periodic basis. The server can be further enabled to cause transfer of payment to the secured line of credit account using a calculated available collateral balance from an immediately previous period such that funds deposited from the immediately previous period which are in the security account are automatically used to pay off an outstanding balance in the secured line of credit account at the end of a present period.

Periodic receipt of the collateral deposit data and periodic transfer of the collateral security data can each occur monthly on a first in first out basis.

Yet a further aspect of the specification provides a method of configuring a collateral security, comprising: receiving periodic collateral deposits into a security account; generating a line of credit up to a predetermined credit limit based on said collateral deposits; and periodically transferring collateral security in the security account to settle any outstanding balance in the line of credit.

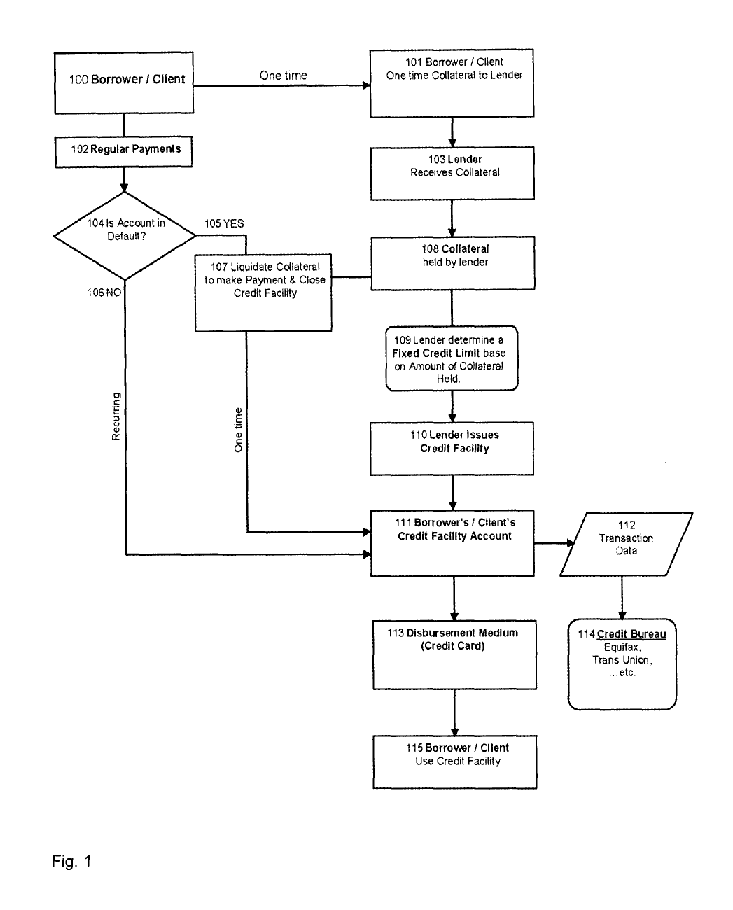

Referring now to the drawings, FIG. 1 is a block diagram illustrating the traditional method for allocating collateral security within traditional forms of collateralized/secured credit instruments. Assuming that the borrower has been approved by the lender, borrower 100 decides the amount of the desired credit limit. Borrower 100 makes a one-time deposit of a collateral security equal to the credit limit at step 101. The collateral can be in the form of cash or asset, in kind, or another asset acceptable by the lender

The lender receives the collateral at step 103 and holds onto the collateral as a deposit at step 108. The lender then determines a fixed credit limit based on the amount of the collateral held at step 109. The lender issues a credit facility [for example, a credit card or a line of credit] at step 110, with a limit equal to the value of the security asset on deposit at step 109.

The lender then credits the facility account at step 111 through a disbursement medium, such as a credit card, at step 113. The borrower would then have access to the available credit through a credit card issued by the lender and be able to use the credit facility at step 115.

On each monthly billing cycle, the borrower 100 is required to make monthly minimum, partial or full payments on any outstanding balances at step 102.

There are two circumstances when the collateral security on deposit may be surrendered or is liquated. Firstly, upon default (at step 104) by the borrower/client, the lender may liquidate or surrender the security on deposit to pay for the outstanding balance and terminate the account and agreement at steps 105, 107, 111. Any surplus funds after payment of outstanding balances and applicable fees may be returned to the borrower.

Secondly (not depicted), the borrower or the lender can decide to terminate the agreement, the full security on deposit is then returned to the borrower less any outstanding fees and balance on the borrower's account.

At the end of each billing (monthly) cycle the lender sends the transaction history/data from the borrower's/client's credit facility account to the credit bureau (steps 112, 114) which will ultimately become part of the borrower's credit history.

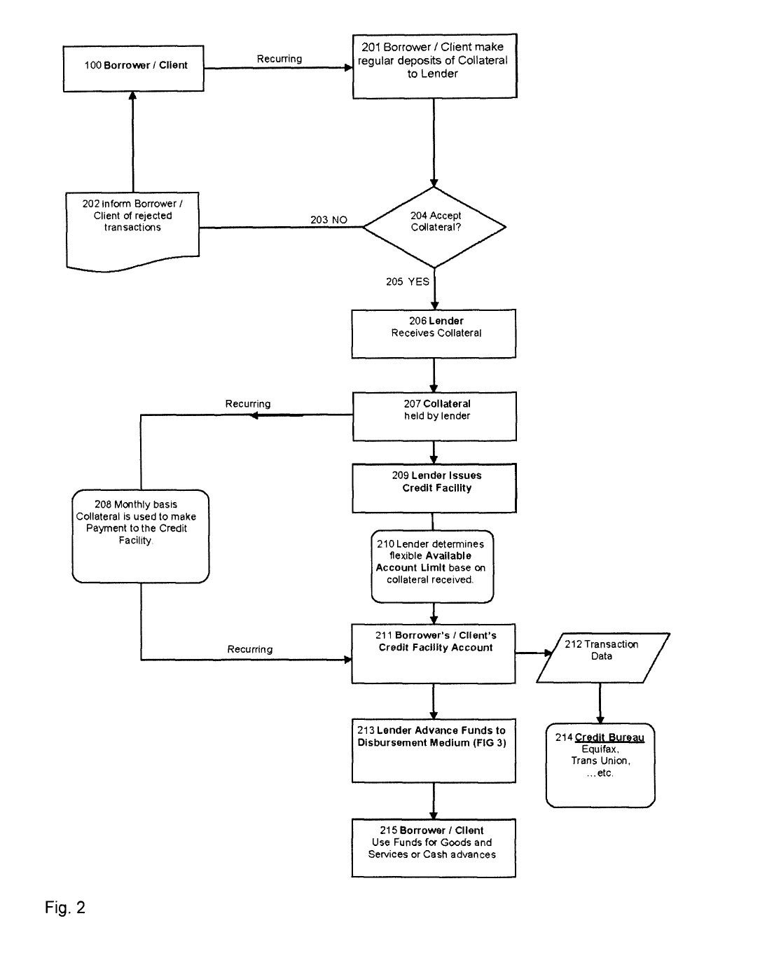

FIG. 2 is a block diagram illustrating the proposed methodology for a variable collateral revolving secured line of credit. Assuming that the borrower has been approved by the lender for a variable collateral revolving secured line of credit, the borrower 100 makes a deposit of collateral to the lender. The type of acceptable collateral security which may be used with the line of credit may be in the form of cash or any marketable assets or securities deemed acceptable by the lender.

On a recurring interval (i.e., weekly, bi-weekly, monthly, bi-monthly, etc., as stated by the lending agreement) the borrower deposits a minimum amount of collateral security with the lender at step 201. This amount shall not exceed the pre-approved credit limit as stated in the borrower and lender's agreement. If the collateral is not acceptable (step 204), the deposit of collateral is rejected and a notice is sent to the borrower at step 202. However, if the deposit is accepted at step 204, the lender will then extend an available account limit to the borrower through the borrower's secured line of credit account. The calculation for “(flexible) available account limit” is the total collateral security on deposit less any applicable fees, less interest charges, and less any advances made in the same period.

The extension of the credit occurs as follows. Firstly, the lender receives the collateral at step 206 and holds onto the collateral as a deposit at step 207. The lender then issues a credit facility at step 209. The lender then determines the (flexible) available account limit based on the collateral received at step 210. In other words, the credit facility 209 embodies the idea of the lender opening an account followed by the lender determining the (flexible) available account limit in step 210 and making it available to the borrower/client for use in step 211.

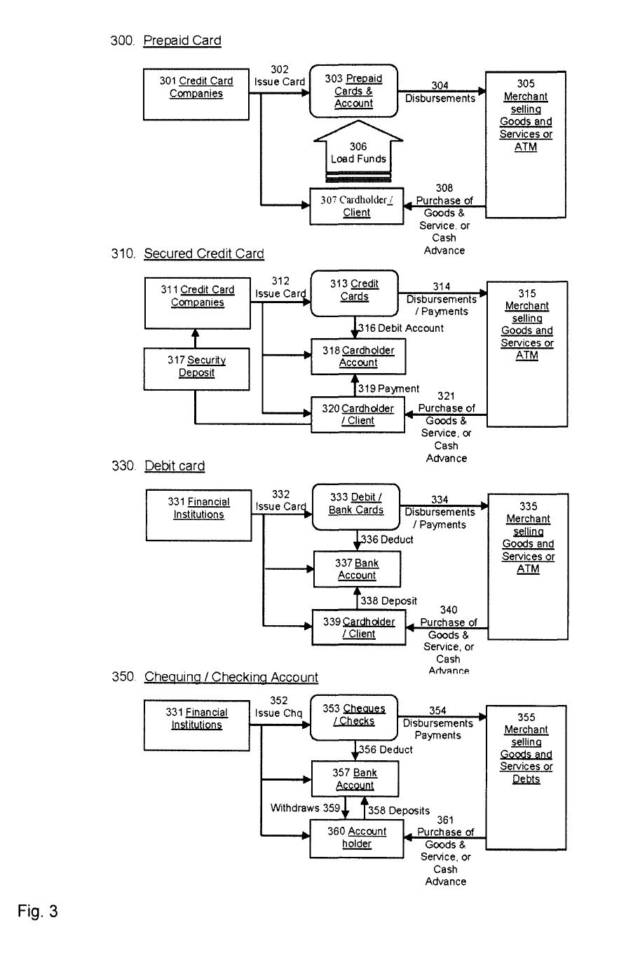

When there is an available account limit (i.e., available funds to be drawn from the credit facility), the lender then credits the facility account at step 211 by automatically advancing funds onto a disbursement medium, at step 213. Further details of the disbursement mediums will be discussed in FIG. 3. The borrower would then have access to the available funds for goods and services or cash advances at step 215.

At the end of each billing period [such as a monthly period], the collateral security is collapsed [or used] by the lender to pay for the outstanding balance in the borrower's credit facility, at step 208. This entire transaction cycle from borrower's collateral deposit with the lender to collateral being collapsed by the lender for payment is repeated in each billing cycle until the agreement between lender and borrower is terminated.

Finally, at the end of each billing cycle, the transaction data (212) collected from the borrower's /client's credit facility account is batched and sent electronically to the respective credit bureaus (214).

The following is an example of how the variable collateral revolving secured line of credit would work in real life. The Client is approved by the lender for the variable collateral revolving secured line of credit with a credit limit of $2,000. He/She make a deposit or transfer of $500 collateral to the lender on the first of the month, step 201. The lender recognizes the collateral of $500, in step 204, and receives and holds the collateral as the lender simultaneously opens and issues the (flexible) available account limit on the client's credit facility (secured line of credit) account. When there is an (a flexible) available account limit available in step 210 (assume in this case it is $498, which is the collateral of $500 less, an assumed, transaction fee of $2), that balance is automatically advanced to a disbursement medium in step 213 for the client's use.

If during the same billing period, the client needs more credit facility he/she makes another deposit, this time for $1,600; however, the lender would reject this transaction because the client's credit limit is $2,000 and advise the client that he/she can only deposit not more than $1,500 in this billing cycle. The client revises its collateral transfer to $1,500 and this amount is recognized by the lender and is subsequently made available to the client; as described in the steps above. According to an alternative embodiment, the lender can automatically cause a payment to the borrower's/client's credit facility account to free up credit limit to allow for the additional transfer of security. Following the previous example, the lender can cause a payment, step 208, an amount up to the amount of collateral held, step 207, but in this case the lender only needs to force a payment of $100 to the credit facility account to free up $100 of additional credit limit for the borrower to transfer the $1,600 of collateral; for a total collateral held, step 207, by the lender equal to $2,000 (calculated as $500 less $100 payment plus $1,600), which is equal to the credit limit.

At the end of the billing cycle, the lender retires (or withdraws) the collateral in a first in first out basis to pay the outstanding balance in the client's credit facility. The advantages of this methodology to the client are: firstly, he/she do not need additional capital or funds to settle his/her credit facility account at the end of a billing cycle. Secondly, account payments are made automatically from existing collateral, which helps to maintain a near perfect payment history. Thirdly, the borrower/client can determine their credit needs on a monthly basis and make deposits to their security account with the lender without having to tie up cash flow in advance. To continue the above example, the $2,000 held as collateral, in step 207, is used to pay the credit facility (or secured line of credit) account, at step 211. The transaction data from the previous billing cycle is reported to the credit bureau by the lender shortly after the start of the new billing cycle. The cycle of collateral deposits/transfers and account payments recurs over again each billing/interval cycle until the client or the lender decides to close the account.

FIG. 3 is a block diagram listing various types of disbursement mediums as described in step 213 of FIG. 2. The purpose of the disbursement medium is to act as a conduit for client/borrower to conveniently access and use funds advanced from the secured line of credit or other forms of secured credit instruments. The following is a short description of the various disbursement mediums:

Prepaid Card (300): This is typically issued (302) by a credit card granter (301) and it is a pre-paid reloadable card (303) that can be used at any merchant where the credit card granter's card is accepted: at stores, gas stations, restaurants, theatres, in the mall and online. It can also be used to get cash from ATMs (304, and 305). Pre-paid cards have a built-in spending limit that is set by the card grantor and limits on how much money can be loaded to the account by the client (306, and 307). When a purchase (308) is made with the prepaid credit card, the purchase amount is deducted from the card balance (303). More money can be added on a regular basis or whenever the money runs low (306).

Secured Credit Card (310): This card (313) is provided by a credit card grantor (311) that entitles the cardholder (320) to buy goods and services or get cash advances from ATMs (314, 315 and 321) based on the holder's promise to pay in the future. Upon receipt of a security deposit (317) from the client the issuer of the card grants a line of credit (318) to the consumer from which the user can borrow money for payments to merchants and for cash advances (314, and 315).

Debit Card (330): This card is also known as a bank card, and it is an alternate payment method to cash. The card is typically linked to a bank account (337) where funds are automatically withdrawn (336) when the card is used to purchase goods and services or for cash advance (334, 335, and 336).

Checking Account (350): This medium is a service offered by a financial institutions (331) (such as a bank, credit union, trust company . . . etc), that allows individuals and businesses to deposit money (358) and withdraw funds (359) from federally protected accounts (357). In general a holder of a checking account can use cheques (checks) in place of cash to pay debts or for purchase of goods and services (354, 355).

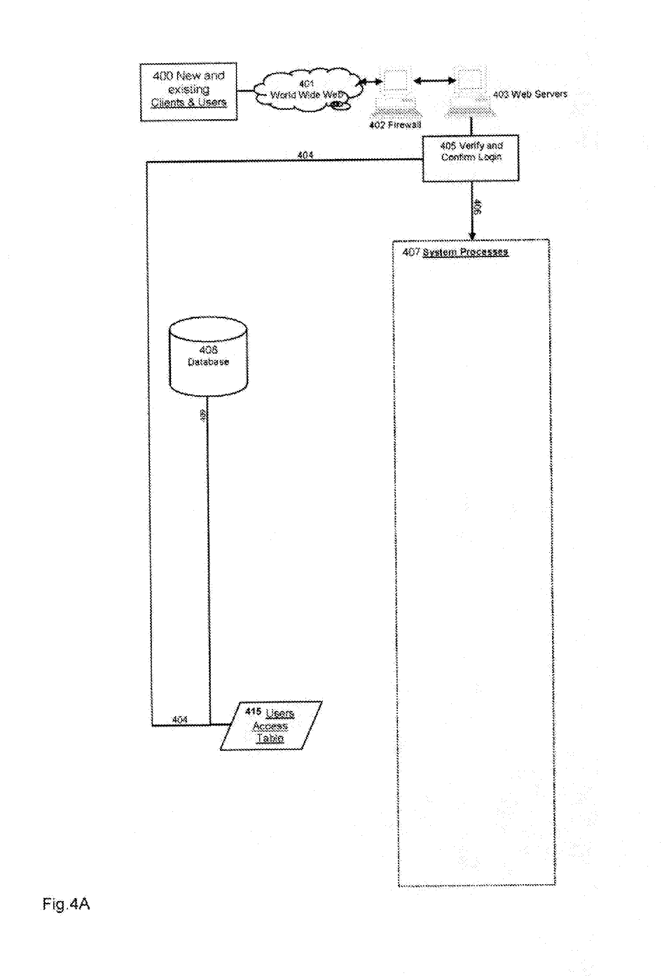

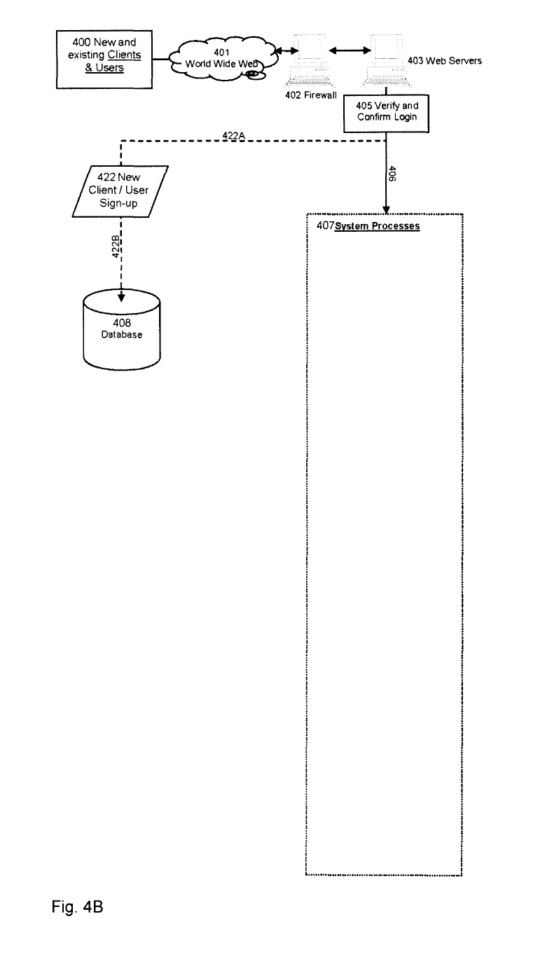

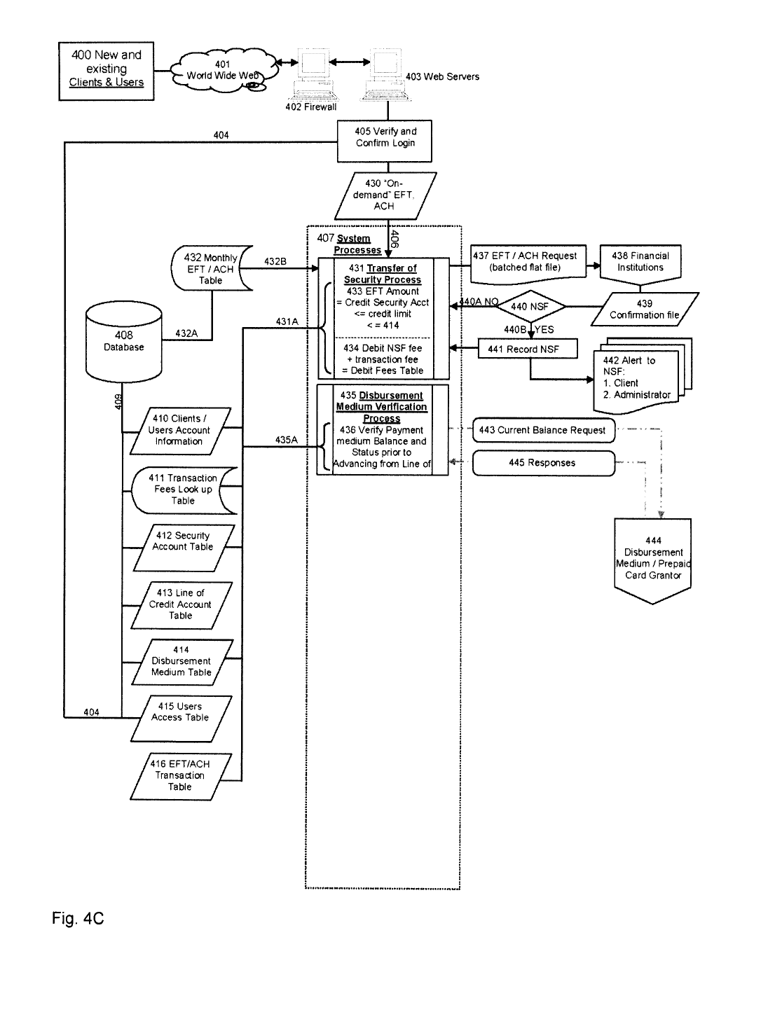

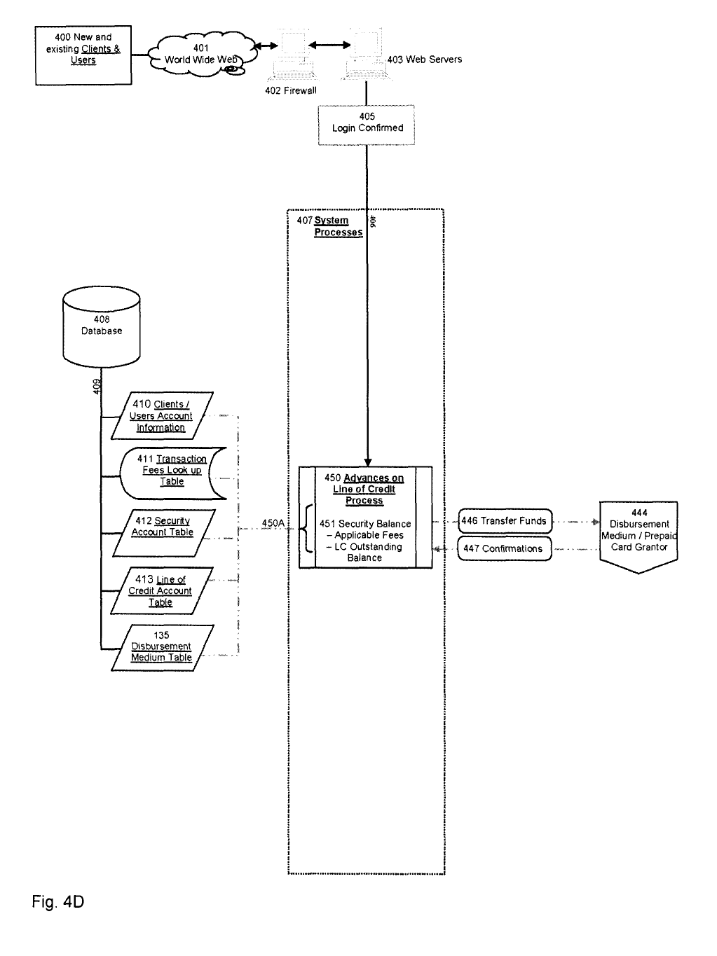

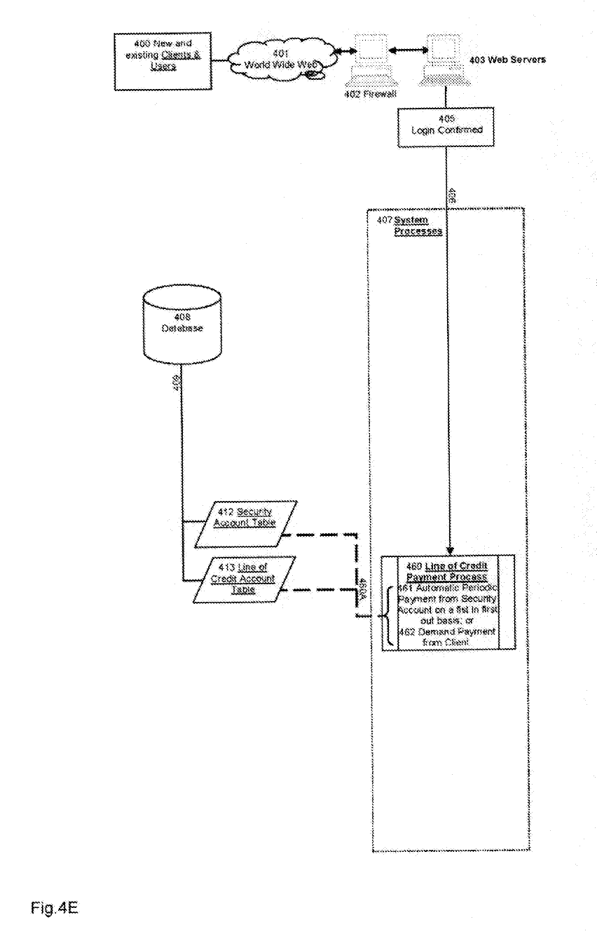

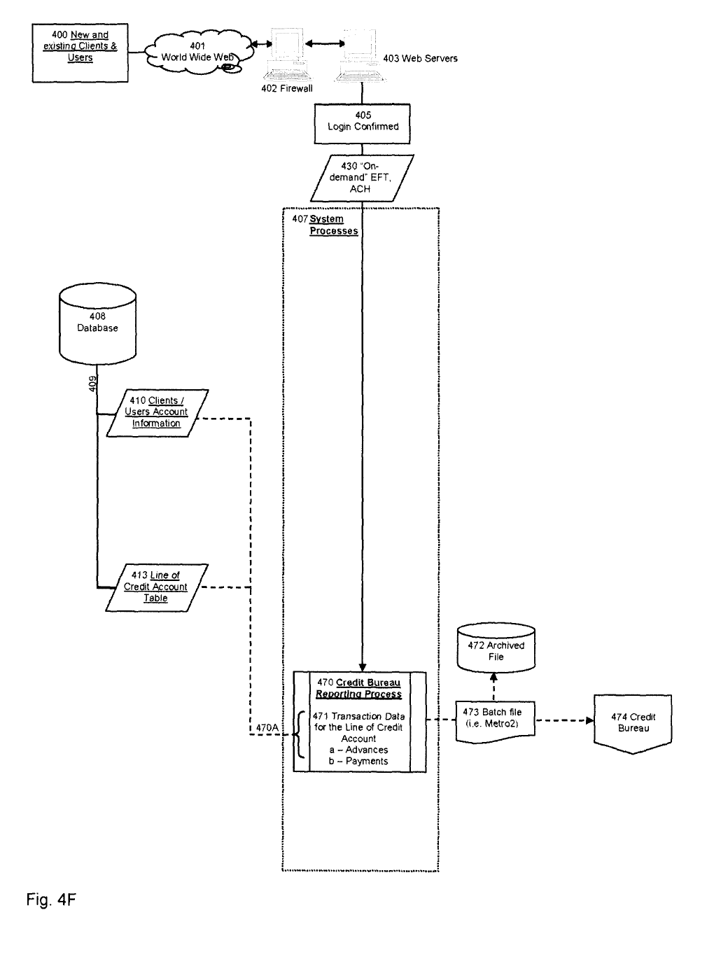

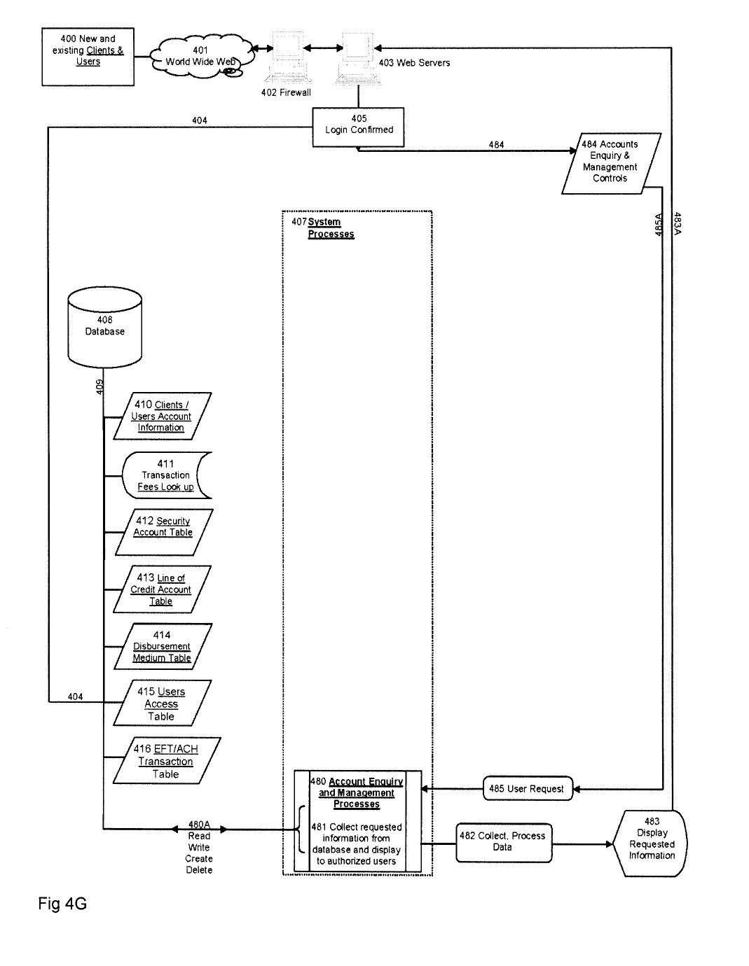

FIG. 4A, 4B, 4C, 4D, 4E, 4F, 4G are flow charts illustrating the flow of information and the relationship between different key system processes for the variable collateral revolving secured line of credit.

FIG. 4A illustrates a process flow for connecting to the system. Clients and Users (400) connect to the system through the Internet/World Wide Web (401) onto a Web Server (403), which connects to a computing device that controls the systems processes and a storage device that stores data for client and user services described below. Upon connection to the server, the client or user must pass through a Firewall (402), and login to the system (405), where, the clients' credentials are verified (405) against information stored in a database (408) user access table (410), prior to being allowed into a protected member area or the client/user can sign-up for a login credential 422 as depicted in FIG. 4B.

FIG. 4B illustrates a process flow for signing up new clients/users. New clients/users (400) submit an online application via the World Wide Web (401). The application data is stored in the Database (408) until the application is reviewed, and an authorized user access profile (410) is created by an account administrator. Once the new client/user (400) is approved, corresponding database table entries are created to open the client's/user's account (422), which is stored (422B) at database 408.

FIG. 4C illustrates a process flow for the transfer of security. There are two ways the system handles client's (400) requests to transfer security from the client's bank account to their security account with the lender. The first is an automatic monthly (EFT (electronic fund transfer)/ACH (automated clearing house)) transfer (432) and the second method is an “on-demand” (EFT/ACH) transfer (430) of funds initiated by the client (400).

Monthly Automatic EFT/ACH Transfer (432): The client (400) sets up a monthly transfer request for a predetermined amount to be transferred at the time of sign-up (FIG. 4B, 422). On a predetermined date each month (or a predetermined cycle period) the system scrubs the database (408) for new clients who have recently signed up and posts any new EFT/ACH requests on to the monthly EFT/ACH Table (432). On a monthly basis (or a predetermined cycle period) the Monthly EFT/ACH requests are submitted to the transfer of security process (430).

Manual “On-demand” EFT/ACH Transfer (430): The client (400) through the World Wide Web (401) sends a request to the web server (403). The system verifies and authenticates the client (405) and allows the client to access the On-demand EFT/ACH request (430) service and to submit a request to transfer funds from their bank account to the lender. The following data is submitted to the transfer of security process (431) for processing: a specific amount of funds to be transferred, on a specific date, and from a specific bank account.

Transfer of Security Process (431): When an automatic (432) or a manual (430) transfer request is submitted to this process the following sequence of events takes place:

(1) Disbursement Medium Verification Process (435/436) is initiated: The system sends a current account balance request (443) to the prepaid card grantor (444), for a specific client's card account which corresponds to the client's account from whom the transfer of security request was received. The prepaid card grantor (444) responds (445) by sending the requested information; the current account balance amount is posted and date stamp to the disbursement medium balance table (414). Each time a transfer of security process (431) is initiated for a client. The system checks the disbursement medium balance table for the prepaid card current account balance and the maximum load limit. The difference between the (prepaid card) maximum load limit and the prepaid card current account balance plus, if any, transaction fees is the “maximum transfer amount” the system will allow a client to transfer at that time. Therefore, any monthly (432) or “on-demand” (430) EFT/ACH transfer amounts must be equal to or less than the lesser of the “maximum transfer amount” determined, from time to time, by the system and the client/user's credit limited as established by the lender when the credit facility was first underwritten. Another embodiment of the credit limit is that the lender can increase or decrease the limit from time to time based on predetermined underwriting guidelines. Similarly, another embodiment for the maximum transfer amount can vary based on the card issuer's decision to increases or decreases to the maximum load limit of the disbursement medium (prepaid card).

(2) Recording EFT/ACH Transactions for Processing (416): The relevant information such as client's name (data from 410), amount of the funds in dollars to be transferred (data from either 430 or 432), and the client's bank account number (data from 410) is packaged, marked “for processing” and stored in the EFT/ACH Transaction Table (416) and awaits for batched transmission (437) to the financial institutions (438).

(3) Processing EFT/ACH Transactions (438): At a predetermined time (or multiple times) each day the system reads the EFT/ACH Transaction Table (416) and batch together transfer requests (initiated at steps 432, and 430) which have been marked “for processing”. Transactions which are batched for processing are then marked as “sent” on the EFT/ACH Transaction Table (416) to avoid mistakenly sending the transaction again. An EFT/ACH Request batched flat file (437) is created and it is sent electronically to the financial institution (438) for processing. The financial institution processes the file and returns a confirmation flat file (439) back to the web server (403) and the system process (431) reads and compares the information with the EFT/ACH Transaction Table (416) to determine if the requested EFT/ACH transactions were successful (440A) or if it has failed (440B). The system marks the transaction in the EFT/ACH Transaction Table (416) as “received” for successful transactions, or for failed transactions the system marks as either: “incomplete” for an incomplete transaction or “NSF” (non-sufficient funds) for failed transaction resulting from nonsufficient funds in the client's bank account. The next two paragraphs describe the series of steps for the posting of information in the various database tables for the tracking of monies and fees from successful and failed transactions.

Posting Successful EFT/ACH Transactions (440A): From the EFT/ACH transaction table (416) for transactions marked “received” the amount of the transferred collateral/security is posted to the security account table (412). If there are any fees associated with the transaction the system obtains the fees from the Transaction fees look up table (411) and posts the sum in the Line of credit account table (413) as a debit entry.

Posting Failed EFT/ACH Transaction (440B): When an EFT/ACH transaction fails (440, 440B), it can fail because the transaction was “incomplete”, or “NSF”; in either case an automated message is sent (442) to alert the client and the account administrator(s) about the failed transaction (440B). An NSF fee and/or transaction fee (411) incurred for the failed transaction is posted to the line of credit account table (413) as a debit entry or an amount owing to the lender. If the line of credit balance exceeds the security account balance, interest may be applied to the balance owing to the lender in excess of the collateral on deposit. The calculation of interest will be discussed below.

FIG. 4D illustrates a process flow for the advancement of funds from the line of credit to a disbursement medium. On a periodic basis and/or after a successful EFT/ACH transaction, the system will automatically trigger an advance on the line of credit process by determining if there is sufficient available balance in the line of credit (credit facility account) to advance funds. The following steps describe the process for advance of funds from line of credit. Firstly, the system determines the available amount that the client's line of credit can advance (“available advance”) by looking up the current balance in the security account table (412) (also call, the “(flexible) available account limit”) minus the total debit balance in the line of credit account table (413). The line of credit account debit balance includes transactions or monthly program fees plus prior advances on the secured line of credit (credit facility) in the current payment (billing) cycle. A payment (billing) cycle is the period between the dates of the last payment on the account to the next payment date; for example, typically a payment cycle is a calendar month. Secondly, the system will load/transfer (446) the available advance amount from the line of credit on to the disbursement medium (444); in this case is the prepaid card by sending a transfer funds request (446) to the prepaid card grantor. On receipt and processing of the load of funds request the card grantor sends back a confirmation (447) electronically to our system and an amount equal to the advance is posted in the Line of credit account table (413).

FIG. 4E illustrates a process flow for a line of credit payment process. On a regular monthly basis (or predetermined payment cycle period) funds from the client's security account (412) is surrendered to pay the debts incurred on the client's line of credit account (413) on a first in first out basis (as described above in FIG. 2). The system checks the balance of the total debt (460) in the line of credit account table (413) on the last day of the month (or last day of the predetermined payment cycle period). An entry equal to the total debt determined above is posted to the security account table (412) to reduce the security in the account and an offsetting entry is posted to the line of credit account table (413) to recognize the payment from the security account for the period.

FIG. 4F illustrates a process flow for credit bureau reporting. On the first day of each month (or in a new payment cycle period) the system extracts (470) the prior month's (or previous payment cycle period's) transactions data from the line of credit account table (413) to compile the transaction data to report to the credit bureaus, such as Equifax, Trans Union, and Experian. Transaction data (413) and data from the client user account information table (410) are used to create a batched file (a Metro or Metro2 format) which is sent electronically to the credit bureaus (474). The batched file subsequently is archived after it has been sent to the credit bureaus (472) for future reference.

FIG. 4G illustrates a process flow for account enquiry and management process. The process begins with the system verifying the client's/user's profile, and access level (405) to determine the client/user functionalities and controls (484). Client/User send accounts enquiry and management requests (485) to the account enquiry and management process (480), which route the request and return the collected processed data (482) and displays the information in a readable format (483) and sends it back to the client/user (400).

Alternate embodiments of this aforementioned methodology may include, but not limited to the following features:
a. The lender may charge a monthly/periodic interval fee for providing service to the borrower/client.
b. A refundable application fee can be used as an incentive to encourage borrower/client to keep their account in good standing because the purpose is to re-establish or establish a good credit history.
c. It is known that trade lines with at least 2 years or more of good payment history is regarded more favourably than a good trade line that is less than 2 years old. Therefore, the lender highly encourages a borrower/client to use the variable collateral revolving secured line of credit (this “credit facility”) for at least 2 to 3 years. It is advantageous to keep this credit facility active indefinitely because of its design to naturally keep itself in good standing can help to mitigate the effect of bad trade lines on client's credit score.
d. A lender can give higher credit limits because of the nature and design of the application to mitigate potential lender's risks. In fact, the risk between a client with a low credit limit and that of a high credit limit are the same.
e. There are limited products in the market for people who are “un-bank”. In other words, people who cannot get or do not have a traditional bank account. This application can serve to help these people to establish good credit so that they will be considered by the banks.
f. Attaching this methodology to the payment for goods and services can help establish and build credit. The variable collateral revolving secured line of credit is one means of helping clients establish and build credit. It can be used as a conduit for payment for goods and services that traditionally when purchased on its own do not create a trade line or establish credit on a credit bureau. For example, paying rent does not build credit; however, if the rent was paid using this methodology as a conduit then the payment is now indirectly reportable to the credit bureau. Other services that this methodology can be attached to includes: money remittance, foreign currency exchange, cheque (check) cashing . . . etc.
g. Further, this methodology can be attached to a company's benefits plan that can help a company's employee establish, build, and improve on their credit.
h. This methodology can be combined with other service oriented businesses that help clients who are afflicted by debts problems; such as trustees in bankruptcy, and credit counselors. These types of businesses and professionals provide solutions to deal with the debt problems, but their services can be further enhanced to provide additional value to their clients by including this methodology to help establish and rebuild their client's credit.
i. To promote awareness about the importance of credit, and to promote the value of this methodology to the public; a lender using this methodology can employ: affiliate marketing, social network marketing, and viral marketing. Greater awareness about credit and the utilization of credit will create a movement towards better credit and money management habits and help to eliminate social tragedies caused by poor and improper use of credits and credit cards.
j. In addition to helping clients establish, build, and improve their credit, this methodology is also designed to promote budgeting, good money management and the idea of living within one's mean, by forcing clients to deposit money into their secured account with us before it is spent, thereby, helping clients to appreciate the proper use of credit. To further enforce the idea of living within one's means in a credit driven society, this methodology disburses funds from our secured credit facility through familiar disbursement mediums; such as a prepaid credit card; which allows the client to use charge cards without the danger of spending beyond their means.

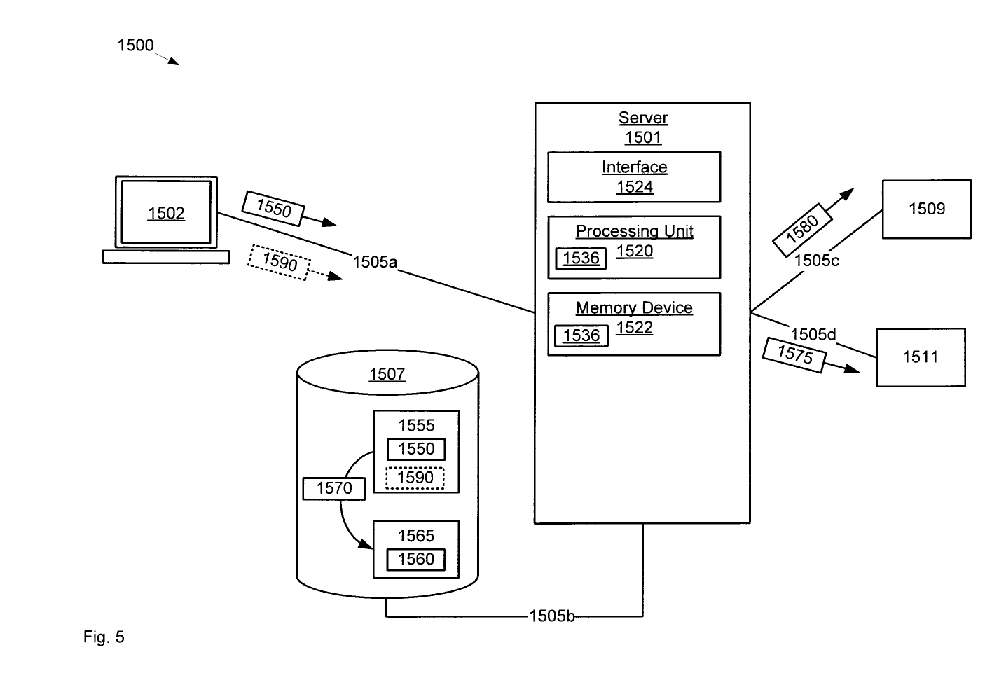

Attention is now directed to FIG. 5 which depicts a system 1500 for configuring a collateral security, according to non-limiting implementations. A server 1501 is enabled for access by a client device 1052 via a communications network 1503. Client device 1502 will also be referred to hereafter as device 1502, and server 1501 will also be referred to hereafter as computing device 1501, server device 1501 and/or device 1501. System 1500 can also comprise a database 1507, a disbursement medium entity 1509 and a credit bureau entity 1511. It is further appreciated that device 1502, database 1507, disbursement medium entity 1509 and credit bureau entity 1511 are all in communication with server 1501 via respective links 1505a, 1505b, 1505c, 1505d (referred to collectively as links 1505 and generically as a link 1505).

Device 1501 comprises a processing unit 1520 interconnected with a memory device 1522, and a communication interface 1524 and optionally a display device (not depicted) and an input device (not depicted), for example via a computing bus (not depicted). Processing unit, 1520, memory device 1522 and communication interface 1524 will also be referred to hereafter as, respectively, processor 1520, memory 1522 and interface 1524. Device 1501 further comprises an application 1536 for configuring a collateral security as will be explained below. Application 1536 can be stored in memory 1522 and processed by processing unit 1520.

Server 1501 can be based on any well-known server environment including a module that houses one or more central processing units (e.g. processing unit 1520), volatile memory (e.g. random access memory), persistent memory (e.g. hard disk devices) (e.g. memory 1522) and network interfaces (e.g. interface 1524) to allow server 1501 to communicate over relevant links, such as links 1505. For example, server 1501 can be a Sun Fire V480 running a UNIX operating system, from Sun Microsystems, Inc. of Palo Alto Calif., and having four central processing units each operating at about nine-hundred megahertz and having about sixteen gigabytes of random access memory. However, it is to be emphasized that this particular server is merely exemplary, and a vast array of other types of computing environments for server 1501 are contemplated. Those skilled in the art will now recognize that non-volatile storage and volatile storage are examples of computer readable media that can store programming instructions executable on the processors of each server. It is further more appreciated that server 1501 can comprise any suitable number of servers that can perform different functionality of server implementations described herein.

Processing unit 1520 comprises any suitable processor, or combination of processors, including but not limited to a microprocessor, a central processing unit (CPU) and the like. Other suitable processing units are within the scope of present implementations. In particular, processing unit 1520 is enabled to process application 1536.

Memory 1522 can comprise any suitable memory device, including but not limited to any suitable one of, or combination of, volatile memory, non-volatile memory, random access memory (RAM), read-only memory (ROM), hard drive, optical drive, flash memory, magnetic computer storage devices (e.g. hard disks, floppy disks, and magnetic tape), optical discs, and the like. Other suitable memory devices are within the scope of present implementations. In particular, memory 1522 is enabled to store application 1536.

Communication interface 1524 comprises any suitable communication interface, or combination of communication interfaces. In particular interface 1524 is enabled to communicate with device 1502, disbursement medium entity 1509 and credit bureau entity 15011 via links 1505. Accordingly, interface 1524 is enabled to communicate according to any suitable protocol including but not limited to wired protocols, wireless protocols, cell-phone protocols, wireless data protocols, Internet protocols, packet-based protocols, analogue, PSTN (public switched telephone network) protocols WiFi protocols, WiMax protocols and/or a combination, or the like.

Database 1507 can be any suitable database and can be stored on one or more database servers (not depicted) in communication with server 1501. Alternatively, database 1507 can be stored at memory device 1522.

Each link 1505 can comprise any suitable combination of wired and/or wireless links as desired including but not limited to cables, wired networks, wireless networks, the Internet, packet-based networks, analog networks, the PSTN, LAN networks, WAN networks, WiFi networks, WiMax networks, or the like.

It is yet further appreciated that device 1502 can be any type of electronic device that can be used in a self-contained manner and to interact with server 1501 via link 1505a. Interaction includes displaying of information on a device 1502 as well as to receive input at a device 15022 that can in turn be sent to server 1501 via link 1505, for example collateral deposit data, as will be explained below.

It is further appreciated that server 1501 can comprise web servers 102 of FIGS. 4A-4G, and that system processes 107 of FIGS. 4A-G can occur at server 1501, for example via processing of application 1536. It is further appreciated that database 1507 can comprise database 111 of FIGS. 4A-4G. It is yet further appreciated that the processes and methodologies of FIGS. 2, 4A-4G can be implemented in system 1500.

It is yet further appreciated that server 1501 is enabled (for example via processor 1502 processing application 1526) to periodically receive, from device 1502 via communication interface 1502 and link 1505a, collateral deposit data 1550 indicative of collateral deposits; cause the periodic collateral deposit data 1550 to be stored in association with a security account 1555 in a first memory device, such as database 1507 (as depicted) and/or alternatively memory 1522. Server 1501 is further enabled to generate line of credit data 1560 indicative of a line of credit, the line of credit data comprising an indication of a predetermined credit limit based on the collateral deposit data 1550, the line of credit data 1560 stored in association with a secured line of credit account 1565 at one or more of the database 1507 (as depicted) and/or alternatively the memory device 1522. Server 1501 is further enabled to periodically cause a transfer of collateral security data 1570 associated with the security account 1555 to settle any outstanding balance associated with the line of credit, for example, by transferring funds from the security account 1555 to the line of credit account 1570.

Server 1501 can be further enabled to cause transaction data 1575 associated with the transfer of collateral security data 1570 to be transmitted to the credit bureau entity 1511 (i.e. a remote computing device associated with a credit bureau) thereby reporting a transaction history associated with the secured line of credit account 1565.

Server 1501 can be further enabled to determine credit balance data associated with the secured line of credit account 1565 on a periodic basis. Server 1501 is further enabled to cause transfer of payment to the secured line of credit account 1565 using a calculated available collateral balance from an immediately previous period (i.e. last month) such that funds deposited from the immediately previous period which are in the security account 1555 are automatically used to pay off an outstanding balance in the secured line of credit account 1565 at the end of a present period (i.e. a current month).

Server 1501 can be further enabled to cause a disbursement medium (i.e. at least one of a prepaid card, a secured credit card, a debit card and a checking account) to be issued for enabling funds associated with the line of credit to be accessed, for example by transmitting a request 1580 to issue the disbursement medium to the disbursement medium entity 1509 (i.e. a remote computing device associated with the disbursement medium entity).

Server 1501 can be further enabled to verify a payment balance associated with the disbursement medium, prior to transmitting payment data for transferring funds from the secured line of credit account 1565 to an account (not depicted) associated with the disbursement medium.

Server 1501 can be further enabled to determine the predetermined credit limit by subtracting from an amount associated with the collateral deposit data 1550 amounts associated with at least one of applicable fees, interest charges, advances, and payments. The applicable fees comprise one or more of at least one transaction fee and a debit non-sufficient funds (NSF) fee.

Server 1501 can be further enabled to receive from device 1502 via communication interface 1502 and link 1505a, further collateral deposit data 1590 indicative of further collateral deposits, which can also be stored in security account 1555. A total amount associated with the collateral deposit data 1565 and the further collateral deposit data can be set to not exceed the predetermined credit limit.

It is further appreciated that periodic receipt of the collateral deposit data 1550 and periodic transfer of the collateral security data 1570 can each occur monthly on a first in first out basis.

Those skilled in the art will appreciate that in some implementations, the functionality of servers 1502, 111 can be implemented using pre-programmed hardware or firmware elements (e.g., application specific integrated circuits (ASICs), electrically erasable programmable read-only memories (EEPROMs), etc.), or other related components. In other implementations, the functionality of servers 1502, 111 can be achieved using a computing apparatus that has access to a code memory (not shown) which stores computer-readable program code for operation of the computing apparatus. The computer-readable program code could be stored on a computer readable storage medium which is fixed, tangible and readable directly by these components, (e.g., removable diskette, CD-ROM, ROM, fixed disk, USB drive). Furthermore, it is appreciated that the computer-readable program can be stored as a computer program product comprising a computer usable medium. Further, a persistent storage device can comprise the computer readable program code. It is yet further appreciated that the computer-readable program code and/or computer usable medium can comprise a non-transitory computer-readable program code and/or non-transitory computer usable medium. Alternatively, the computer-readable program code could be stored remotely but transmittable to these components via a modem or other interface device connected to a network (including, without limitation, the Internet) over a transmission medium. The transmission medium can be either a non-mobile medium (e.g., optical and/or digital and/or analog communications lines) or a mobile medium (e.g., microwave, infrared, free-space optical or other transmission schemes) or a combination thereof.

Persons skilled in the art will appreciate that there are yet more alternative implementations and modifications possible, and that the above examples are only illustrations of one or more implementations. The scope, therefore, is only to be limited by the claims appended hereto.

What is claimed is:

1. A computing device for configuring a collateral security, comprising:
a processor, and a communication interface, the processor enabled to:
periodically receive, via the communication interface, collateral deposit data indicative of collateral deposits;
cause the periodic collateral deposit data to be stored in association with a security account in a first memory device;
generate line of credit data indicative of a line of credit, the line of credit data comprising an indication of a predetermined credit limit based on the collateral deposit data, the line of credit data stored in association with a secured line of credit account at one or more of the first memory device and a second memory device; and
periodically cause a transfer of collateral security data associated with the security account to settle any outstanding balance associated with the line of credit.

2. The computing device of claim 1, wherein the processor is further enabled to cause a disbursement medium to be issued for enabling funds associated with the line of credit to be accessed.

3. The computing device of claim 2, wherein the disbursement medium comprises at least one of a prepaid card, a secured credit card, a debit card and a checking account.

4. The computing device of claim 2, wherein the processor is further enabled to verify a payment balance associated with the disbursement medium, prior to transmitting payment data for transferring funds from the secured line of credit account to an account associated with the disbursement medium.

5. The computing device of claim 1, wherein the processor is further enabled to cause transaction data associated with the transfer to be transmitted to a remote computing device associated with a credit bureau to thereby reporting a transaction history associated with the secured line of credit account.

6. The computing device of claim 1, wherein the processor is further enabled to determine the predetermined credit limit by subtracting from an amount associated with the collateral deposit data amounts associated with at least one of applicable fees, interest charges, advances, and payments.

7. The computing device of claim 6, wherein the applicable fees comprise one or more of at least one transaction fee and a debit non-sufficient funds (NSF) fee.

8. The computing device of claim 1, wherein the processor is further enabled to receive, via the communication interface, further collateral deposit data indicative of further collateral deposits.

9. The computing device of claim 7, wherein a total amount associated with the collateral deposit data and the further collateral deposit data does not exceed the predetermined credit limit.

10. The computing device of claim 1, wherein the processor is further enable to determine credit balance data associated with the secured line of credit account on a periodic basis.

11. The computing device of claim 10, wherein the processor is further enabled to cause transfer of payment to the secured line of credit account using a calculated available collateral balance from an immediately previous period such that funds deposited from the immediately previous period which are in the security account are automatically used to pay off an outstanding balance in the secured line of credit account at the end of a present period.

12. The computing device of claim 1, wherein periodic receipt of the collateral deposit data and periodic transfer of the collateral security data each occur monthly on a first in first out basis.

13. A system for configuring a collateral security, comprising:
a server enabled to control systems processes and store data for client and user services, the server further enabled to:
periodically receive collateral deposit data indicative of collateral deposits;
cause the periodic collateral deposit data to be stored in association with a security account;
generate line of credit data indicative of a line of credit, the line of credit data comprising an indication of a predetermined credit limit based on the collateral deposit data, the line of credit data stored in association with a secured line of credit account; and
periodically cause a transfer of collateral security data associated with the security account to settle any outstanding balance associated with the line of credit.

14. The system of claim 13, further comprising a database for storing at least one of:
an EFT/ACH (electronic fund transfer)/automated clearing house) transfer table;
client account information;
user account information;
a transaction fee look-up table;
a security account table;
a line of credit account table;
a disbursement medium table; and
a user access table.

15. The system of claim 13, further comprising a disbursement medium grantor entity for issuing at least one disbursement medium for enabling funds associated with the line of credit to be accessed

16. The system of claim 13, wherein the server is further enabled to determine credit balance data associated with the secured line of credit account on a periodic basis.

17. The system of claim 16, wherein the server is further enabled to cause transfer of payment to the secured line of credit account using a calculated available collateral balance from an immediately previous period such that funds deposited from the immediately previous period which are in the security account are automatically used to pay off an outstanding balance in the secured line of credit account at the end of a present period.

18. The system of claim 13, wherein periodic receipt of the collateral deposit data and periodic transfer of the collateral security data each occur monthly on a first in first out basis.

19. A method of configuring a collateral security, comprising:
receiving periodic collateral deposits into a security account;
generating a line of credit up to a predetermined credit limit based on said collateral deposits; and
periodically transferring collateral security in the security account to settle any outstanding balance in the line of credit.
